(19) United States
(12) Patent Application Publication
(10) Pub. No.: US 2010/0171307 A1
(43) Pub. Date: Jul. 8, 2010

(54) FITTING ASSEMBLY WITH FERRULE

(75) Inventor: Allen Tymkewicz, Westlake, OH (US)

Correspondence Address: PEARNE & GORDON LLP, 1801 EAST 9TH STREET, SUITE 1200, CLEVELAND, OH, 44114-3108, US

(73) Assignee: MARLIN MANUFACTURING CORPORATION, Cleveland, OH (US)

(21) Appl. No.: 12/652,202

(22) Filed: Jan. 5, 2010

Related U.S. Application Data
(60) Provisional application No. 61/142,529, filed on Jan. 5, 2009.

(51) Int. Cl. F16L 19/00; B23P 11/00

(52) U.S. Cl. 285/342; 29/505

(57) ABSTRACT

An example apparatus and method of using the apparatus are provided that include a fitting assembly configured to secure an instrument probe. A body portion of the fitting assembly includes a bore for receiving the instrument probe. A ferrule is configured for receiving and aligning the instrument probe. The ferrule includes an alignment feature configured for contacting the bore upon insertion into the body portion. The alignment feature of the ferrule constricts in response to contact with the bore to pre-align the ferrule for reception of the instrument probe. The fitting assembly can be used in a thermocouple arrangement such as with at least one connector.

### RELATED APPLICATION

Benefit of priority is claimed from Provisional Patent Application Ser. No. 61/142,529, filed Jan. 5, 2009, the disclosure of which is incorporated herein by reference.

### FIELD OF THE INVENTION

The present invention relates to improvements in the design, construction and manufacture of a self-aligning ferrule for a process fitting.

### BACKGROUND OF THE INVENTION

Connectors are utilized to interconnect a thermocouple probe or instrument probe within a thermocouple system. One portion of the connection arrangement is interconnected with a probe member. A second portion of the connection arrangement can be connected to a wire that may extend to a strip panel. In turn, the strip panel may be operatively connected via cable or the like to one or more instruments.

As part of such a connector arrangement, connectors must be assembled, connected onto leads, and the like. Some of these process steps require alignment of parts.

### SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, a fitting assembly is configured to secure an instrument probe. The fitting assembly includes a body portion and a ferrule. The body portion includes a bore for receiving the instrument probe. The ferrule is configured for receiving and aligning the instrument probe, where the ferrule includes an alignment feature configured for contacting the bore upon insertion into the body portion. The alignment feature of the ferrule constricts in response to contact with the bore to pre-align the ferrule for reception of the instrument probe.

In accordance with another aspect of the present invention, a fitting assembly is configured to secure an instrument probe. The fitting assembly includes a body portion, a ferrule, and a pusher mechanism. The body portion includes a bore for receiving the instrument probe. The ferrule is configured for receiving and aligning the instrument probe, where the ferrule includes an alignment feature configured for contacting the bore upon insertion into the body portion. A pusher mechanism is configured for engaging the ferrule and inserting the ferrule into the bore. The alignment feature of the ferrule constricts in response to contact with the bore to pre-align the ferrule for reception of the instrument probe.

In accordance with yet another aspect of the present invention, a method of assembling a fitting assembly for securing an instrument probe includes the step of providing a body portion including a bore for receiving the instrument probe. The method further includes the step of providing a ferrule configured for receiving and aligning the instrument probe, wherein the ferrule includes an alignment feature configured for contacting the bore upon insertion into the body portion. The method further includes the step of inserting the ferrule into the bore of the body portion, where the alignment feature constricts in response to contact with the bore to pre-align the ferrule for reception of the instrument probe.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is an illustration of an example system that utilizes a thermocouple connector arrangement in accordance with the present invention;

FIG. 2 is a perspective view showing a partial assembled state of the connector end of FIG. 1 with a first example fitting assembly;

FIG. 3 is a perspective view of the first example fitting assembly of FIG. 2;

FIG. 4 is a sectional view of the first example fitting assembly of FIG. 2;

FIG. 5 is a perspective view showing a partial assembled state of a connector end with a second example fitting assembly;

FIG. 6 is a sectional view of the second example fitting assembly of FIG. 5; and

FIG. 7 is a sectional view of a third example fitting assembly.

### DESCRIPTION OF EXAMPLE OF EMBODIMENTS

Example embodiments that incorporate one or more aspects of the present invention of the subject application are described and illustrated in the drawings. These illustrated examples are not intended to be a limitation on the subject application. For example, one or more aspects of the subject application can be utilized in other embodiments and even other types of devices. Moreover, certain terminology is used herein for convenience only and is not to be taken as a limitation on the subject application. Still further, in the drawings, the same reference numerals are employed for designating the same elements.

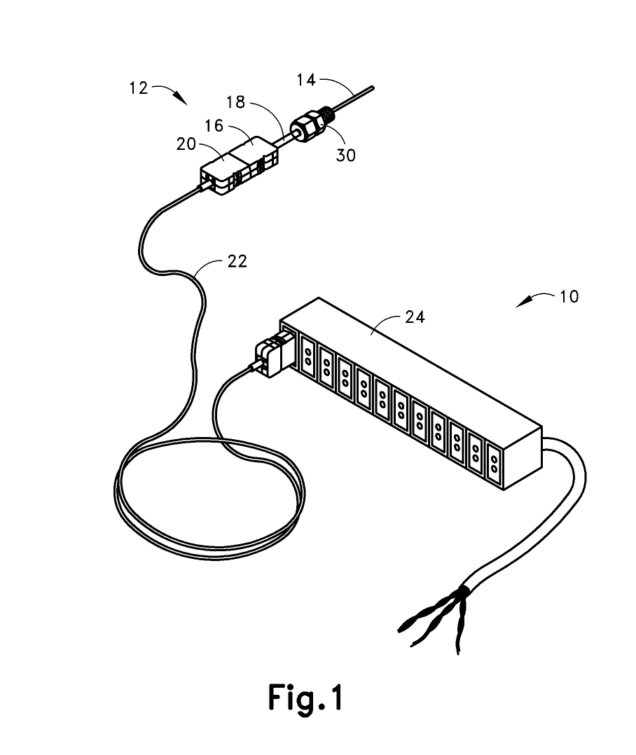

An example thermocouple system 10 that utilizes a thermocouple connector arrangement 12 in accordance with one aspect of the present invention is shown in FIG. 1. Within the example system 10, the connector arrangement 12 is utilized to connect a thermocouple probe or instrument probe 14 to other portions of the system. In the shown example, the instrument probe 14 is elongate and rigid. However, it is contemplated that other configurations are possible.

A first connector 16 of the connection arrangement 12 is interconnected with the instrument probe 14. Specifically, the first connector 16 is configured to have a thermocouple probe lead 18 extending therefrom, and the first connector has an interior configured to receive an electrical connection terminus of the thermocouple probe lead 18. The instrument probe 14 is in connection with the thermocouple probe lead 18 through the use of a fitting assembly 30. The first connector 16 can also further have structure to support the thermocouple probe lead 18 in a static position relative to the first connector 16.

A second connector 20 of the connection arrangement 12 is connected to an electrical connection lead, such an elongate wire cable 22. The electrical connection lead can be elongate and flexible. The second connector 20 is configured to have the electrical connection lead extending therefrom, and the second connector 20 has an interior configured to receive a terminus of the electrical connection lead. It is to be appreciated that the designations of first and second for the connectors are merely for ease of identification.

In the shown example system 10, the wire cable 22 extends to a strip panel 24. In turn, the strip panel 24 is operatively connected via cable or the like to one or more instruments (not shown). It is to be appreciated that the shown example system 10 may have different components, structure, etc., and these aspects of the system 10 are not specific limitations upon the present invention.

The first connector 16 is connected in a mating manner to the second connector 20. The first and second connectors 16 and 20 include electrically conductive mating parts that, when mated, provide an electrical conduction path between the thermocouple probe lead 18 and the wire cable (electrical connection lead) 22. For example, the first connector 16 can have prongs that are plugged into the second connector 20. It is to be appreciated that the specifics of the electrically conductive mating parts may not be a limitation on the present invention.

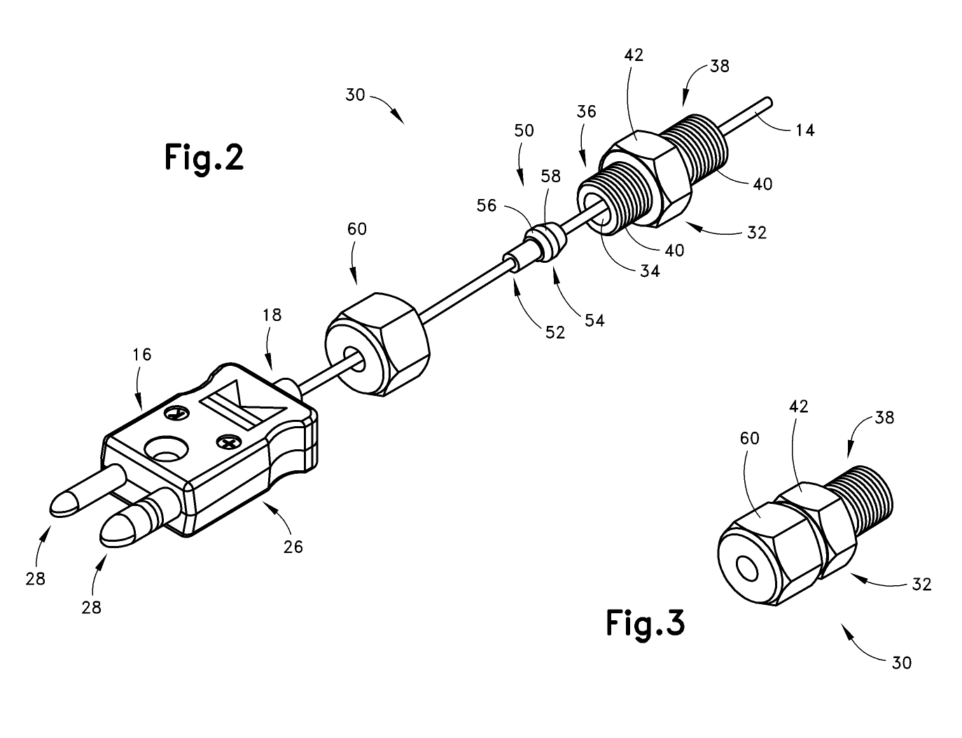

FIG. 2 is a perspective view of an example system including one of the connectors of the arrangement 12 shown in FIG. 1. The shown connector happens to be a plug connector and is the first connector 16 in the shown example. However, it is to be appreciated that at least some of the structural features shown for the first connector 16 may be applicable for the second connector 20.

The first connector 16 can include a housing 26 from which two metal prongs 28 extend. The housing 26 can include multiple portions that are secured together, such as a top portion and a bottom portion. The housing 26 includes an interior configured to receive an electrical connection terminus of the thermocouple probe lead 18. The second connector 20 of FIG. 1 can also include a housing.

A substantial portion of each prong 28 extends from a front end of the housing 26 for connection to another connector. However, a rear end portion of each prong 28 extends rearward from the front portion of the housing 26. The rear end portion (not shown) of each prong 28 is located in the interior of the housing 26. These prong end portions are provided for electrical connection to wires corresponding to the thermocouple probe lead 18. Bared wires received by the first connector 16 can be placed in contact with each prong 28 to establish an electrical connection.

The fitting assembly 30 is further shown in FIG. 2. The fitting assembly 30 can be spaced a distance from the first connector 16. The fitting assembly 30 includes a body portion 32 with a bore 34 for receiving the thermocouple probe lead 18. The body portion 32 can include a first end 36 and a second end 38. The first end 36 can include structure, such as a plurality of threads 40, configured to allow the body portion 32 to be secured to other structure, such as a nut. The second end 38 can include structure, such as a plurality of threads 40, configured to allow the body portion 32 to be secured to another member, such as a pipe (not shown). Thus, the fitting assembly 30 is configured to secure the thermocouple probe lead 18 relative to the instrument probe 14 within another member, such as a pipe (not shown). The body portion 32 can also further include a middle portion 42 that does not include threads. Alternatively, the middle portion 42 be configured to have surfaces for rotational driving (e.g. can include a fastener such as a nut). In other examples, structure other than threads can be provided that is configured to allow the body portion 32 to be attached to various connectors or other structure. The alternative structure includes but is not limited to providing a snap-fit or a force-fit.

The fitting assembly 30 further includes a ferrule 50. The ferrule 50 is configured for receiving and aligning the instrument probe 14. The instrument probe 14 is inserted into an aperture 52 of the ferrule 50. The ferrule 50 includes an alignment feature 54 configured for contacting the bore 34 of the body portion 32 upon insertion of the ferrule 50 into the body portion 32. The alignment feature 54 aids in the proper alignment of the ferrule 50 itself within the body portion 32. The alignment feature 54 also aids in the pre-alignment of the ferrule 50 before the instrument probe 14 is inserted in the fitting assembly 30. The alignment feature 54 in this example is a generally enlarged portion with a larger diameter than the bore 34 of the body portion 32. In the specific example shown, the alignment feature 54 includes a first portion 56 of a first enlarged diameter and a second portion 58 of a second enlarged diameter. The second portion 58 can be located in the middle of the first portion 56 such that the ferrule 50 has an increasingly larger diameter when traversing from one end of the ferrule to another end.

The fitting assembly in FIG. 2 can also further include a nut 60. The nut 60 is configured for engaging the first end 36 of the body portion 32. In this example, the nut 60 can engage the threads 40 on the body portion 32. As the nut 60 is inserted on the body portion 32, the nut 60 contacts the ferrule 50 for inserting the ferrule 50 into the bore 34. For example, the nut 60 can push the ferrule 50 into the bore 34 as the nut 60 engages additional threads 40 on the body portion 32. The alignment feature 54 of the ferrule 50 constricts in response to contact with the bore 34 to align the ferrule 50 that receives the instrument probe 14. For example, the alignment feature 54 can include an enlarged portion relative to the bore 34 of the body portion 32. As the enlarged portion of the alignment feature 54 is inserted into the bore 34 of the body portion 32, the alignment feature 54 is constricted or deformed. In a further example, as the alignment feature 54 is constricted, this forms an engagement of the ferrule 50 with the instrument probe 14. In any of the examples, the ferrule 50 can be made from a number of materials, including but not limited to Teflon, which has flexible properties. Other materials of varying flexibility can also be used for making the ferrule 50.

The fitting assembly 30 is shown in an assembled state in FIG. 3. The assembled state corresponds to the fitting assembly 30 being assembled with the nut 60 engaging the first end 36 of the body portion 32 and the aperture 52 of the ferrule 50 being pre-aligned in the bore 34 of the body portion 32. The fitting assembly 30 can be provided to users or customers in this state. The pre-alignment of the aperture 52 of the ferrule 50 in the body portion 32 allows the instrument probe 14 to be inserted through the fitting assembly 30. After the instrument probe 14 is inserted through the fitting assembly 30, a user can tighten the nut 60 on the body portion 32 to secure the instrument probe 14 to the body portion 32 of the fitting assembly 30 by finalizing the position of the ferrule 50 relative to the instrument probe 14.

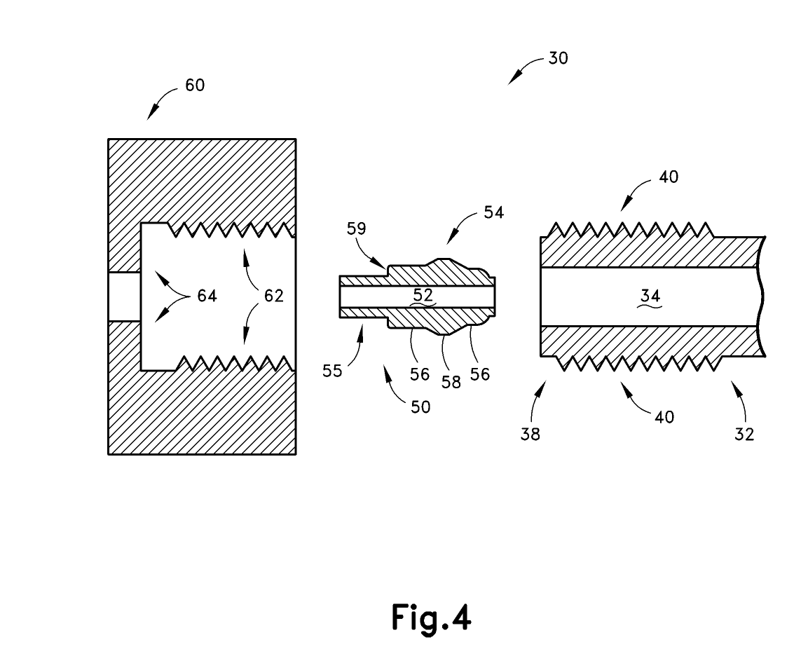

As shown in FIG. 4, a sectional view of the fitting assembly 30 is provided. In this view, the nut 60 is shown along with the threads 62 of the nut 60. The threads 62 of the nut 60 are configured to engage the threads 40 on the body portion 32. In addition, the nut 60 includes a first contact surface 64 for contacting the ferrule 50. The first contact surface 64 will push the ferrule 50 into the bore 34 of the body portion 32. The first contact surface 64 can contact the alignment feature 54 in this example. In another example, the alignment feature 54 can terminate in a shoulder 59. The shoulder 59 is configured to be placed in contact with the first contact surface 64 of the nut 60. The shoulder 59 can have a relatively straight surface, an angled surface, or a curved surface. An end portion 55 of the ferrule 50 can have a smaller thickness than the alignment feature 54. Alternatively, the first contact surface 64 can contact the end portion 55 in some examples.

As further shown in FIG. 4, the alignment feature 54 of the ferrule 50 includes an enlarged portion, where the alignment feature 54 has a larger diameter or thickness in comparison to the bore 34 of the body portion 32. The enlarged portion of the alignment feature 54 will be forced to be constricted as it enters the bore 34 of the body portion 32. The constriction of the alignment feature 54 of the ferrule 50 aids in aligning the ferrule 50 for reception of the instrument probe 14. In other examples, different geometries, shapes, orientations, and sizes can be used for the alignment feature 54 such that the alignment feature 54 is still configured to align the ferrule 50 upon insertion into the body portion 32. Other types of engagement between the alignment feature 54 and the bore 34 can be provided to secure the alignment feature 54 in the bore 34.

Alternatively, different geometries and thicknesses for the ferrule 50 and for the alignment feature 54 and the end portion 55 can be provided. For example, the ferrule 50 can have an alignment feature 54 that has a larger diameter or thickness than the diameter or thickness of the bore 34 of the body portion 32, while the end portion 55 of the ferrule 50 can have an even larger diameter or thickness than the alignment feature 54. The larger diameter will form a larger contact area with the nut 60, or other structure of the fitting assembly 30.

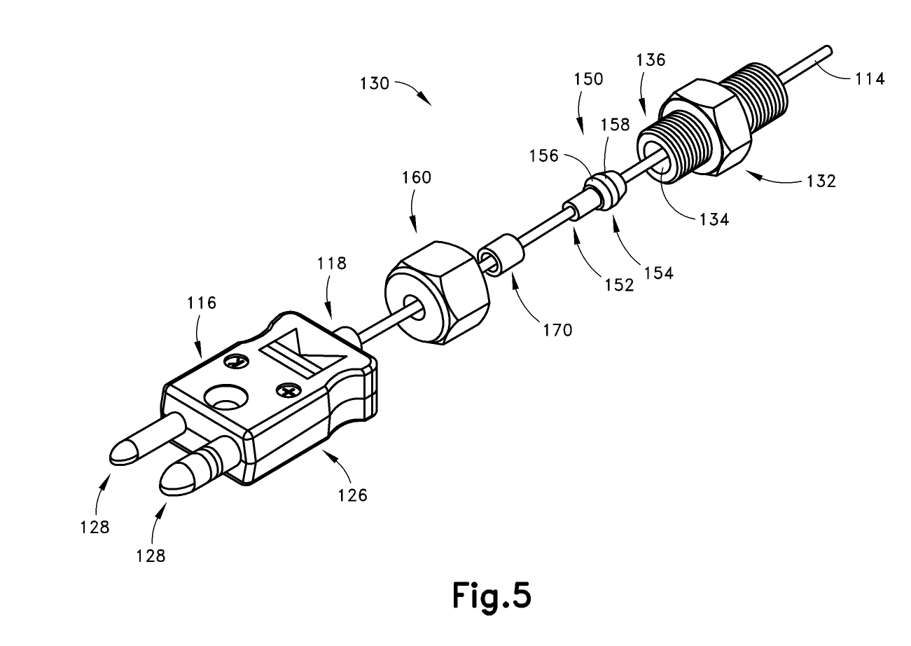

FIG. 5 shows a second example fitting assembly 130. The second example fitting assembly 130 includes similar components and reference numbers as the first example fitting assembly 30. Thus, the second example fitting assembly can also include, for example, a body portion 132, a bore 134 in the body portion 132, a ferrule 150, and an alignment feature 154. The second example fitting assembly 130 further includes a pusher mechanism 170. The pusher mechanism 170 is configured for engaging the ferrule 150 and inserting the ferrule 150 into the bore 134. The alignment feature 154 of the ferrule 150 constricts in response to contact with the bore 134 to align the ferrule 150 for reception of the instrument probe 114. A nut 160 can be provided for engaging a first end 136 of the body portion 132. The nut 160 can contact the pusher mechanism 170 for inserting the alignment feature 154 of the ferrule 150 into the bore 134 of the body portion 132.

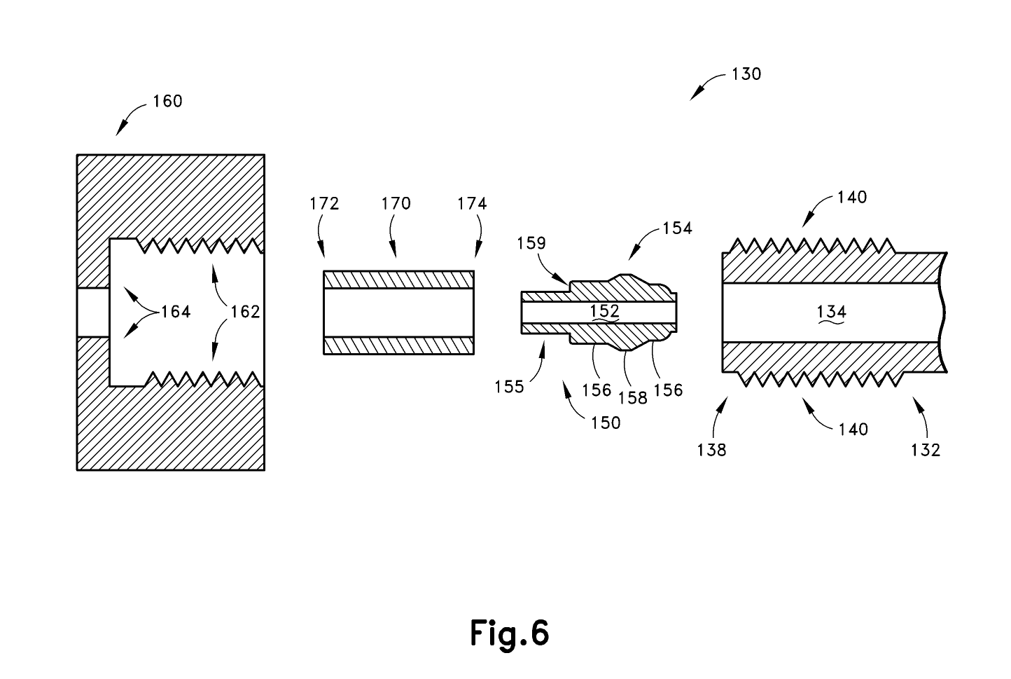

As shown in FIG. 6, a sectional view of the second example fitting assembly 130 is provided. A nut 160 can be provided that is configured for engaging a first end 172 of the pusher mechanism 170. In this example, the first contact surface 164 of the nut 160 is configured to engage the first end 172 of the pusher mechanism 170. In other examples, different geometries and orientations can be provided for the nut 160 and its engagement with the pusher mechanism 170. A second end 174 of the pusher mechanism 170 is configured for engaging the ferrule 150. In the example shown, the second end 174 of the pusher mechanism 170 engages the alignment feature 154 of the ferrule 150. In another example, the alignment feature 154 can terminate in a shoulder 159. The shoulder 159 is configured to be placed in contact with the second end 174 of the pusher mechanism 170. Thus, in this example, during assembly of the second example fitting assembly 130, the pusher mechanism 170 will also receive the end portion 155 of the ferrule 150. In other examples, the second end 174 of the pusher mechanism 170 can engage the smaller, end portion 155 of the ferrule 150. In yet another alternative example, the end portion 155 can have a larger thickness or diameter than the alignment feature 154, and the pusher mechanism 170 can apply force to the end portion 155. In another alternative example, the pusher mechanism 170 and the ferrule 150 can be secured to one another or even be provided as a unitary structure.

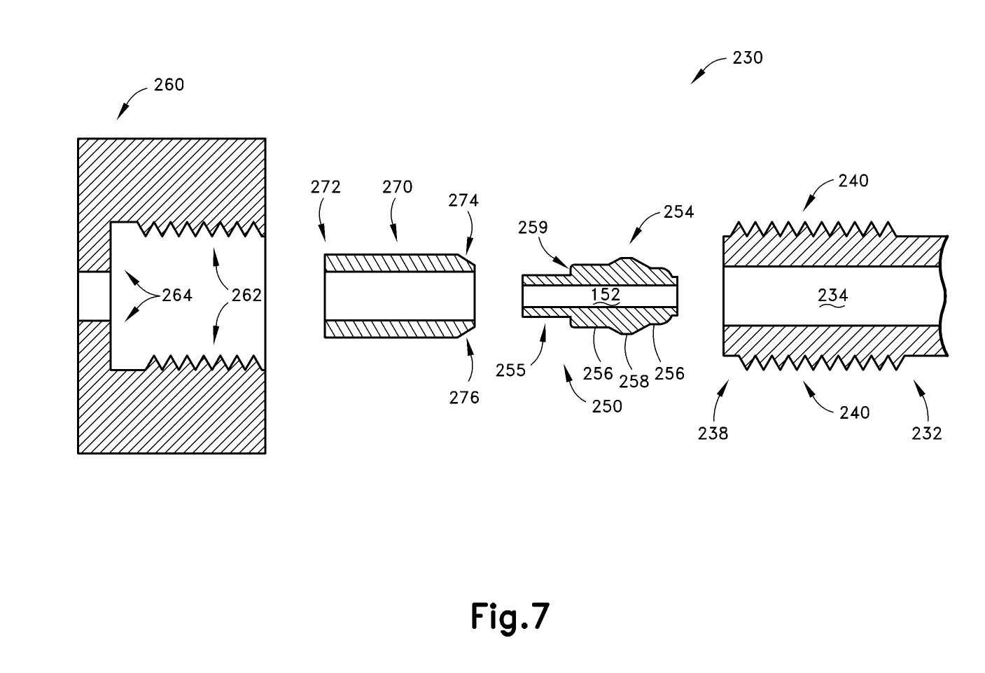

As shown in FIG. 7, a third example fitting assembly 230 is provided. The third example fitting assembly 230 includes similar components and reference numbers as the first example fitting assembly 30. Thus, the third example fitting assembly also includes, for example, a body portion 232, a bore 234 in the body portion 232, a ferrule 250, and an alignment feature 254. The third example fitting assembly 230 further includes a pusher mechanism 270. A nut 260 can be provided that is configured for engaging a first end 272 of the pusher mechanism 270. The first end 272 of the pusher mechanism 270 can be substantially flat for contacting the nut 260. A second end 274 of the pusher mechanism 270 is configured for engaging the ferrule 250. The pusher mechanism 270 in this example includes a tapered or conical shaped portion 276 on the second end 274. The tapered or conical shaped portion 276 can provide an improved seal for the ferrule 250. For example, the conical shaped portion 276 can be configured to transfer the translational movement of the nut 260 and the pusher mechanism 270 directly onto the alignment feature 254. In another example, the alignment feature 254 can terminate in a shoulder 259. The shoulder 259 is configured to be placed in contact with the second end 274 of the pusher mechanism 270. The fitting assembly 30, 130, 230 in any of the examples can be utilized in a number of different systems, including but not limited to the thermocouple arrangement shown in FIG. 1.

A method of assembling a fitting assembly for securing an instrument probe will now be described with respect to a system including one of the example fitting assemblies 30, 130, 230. It will be appreciated that similar or identical method steps may be performed with further examples, for instance, as described throughout the application. Moreover, example methods of the present invention may omit and/or add additional steps. Moreover, unless noted, the steps can be performed simultaneously, sequentially or in different orders depending on the particular application.

As shown in FIGS. 2-4, methods of assembling a fitting assembly 30 are provided. In a first example method, a method is provided for assembling a fitting assembly for securing an instrument probe 14. The method includes the step of providing a body portion 32 including a bore 34 for receiving the instrument probe 14. The method also includes the step of providing a ferrule 50 configured for receiving and aligning the instrument probe 14, wherein the ferrule 50 includes an alignment feature 54 configured for contacting the bore 34 upon insertion into the body portion 32. In addition, the method includes the step of inserting the ferrule 50 into the bore 34 of the body portion 32. The alignment feature 54 of the ferrule 50 constricts in response to contact with the bore 34 to pre-align the ferrule 50 for reception of the instrument probe 14.

In yet another example, the first example method can further include the step of providing a pusher mechanism 170 configured for engaging the ferrule 50 and inserting the ferrule 50 into the body portion 32. The first example method can also further include fastening a nut 60 on a first end 36 of the body portion 32, wherein fastening of the nut 60 inserts the alignment feature 54 of the ferrule 50 into the bore 34 of the body portion 32. The alignment feature 54 constricts in response to contact with the bore 34 to engage and pre-align the ferrule 50 for reception of the instrument probe 14. The pre-alignment of the aperture 52 of the ferrule 50 in the body portion 32 allows an operator of the thermocouple system 10 or the thermocouple arrangement 12 to avoid having to assemble every piece individually one at a time on to the instrument probe 14, as the aperture 52 of the ferrule 50 provides a guide for insertion of the instrument probe 14. Thus, the instrument probe 14 can be inserted into the fitting assembly 30 without taking apart the fitting assembly 30. The fitting assembly 30 can include the body portion 32 and the ferrule 50 with the alignment feature 54. In addition, the fitting assembly 30 can further include the nut 60 and/or the pusher mechanism 70. In one example of not taking apart the fitting assembly 30 during the insertion of the instrument probe 14, the instrument probe 14 can be inserted into the body portion 32 of the fitting assembly 30 without removing the ferrule 50 from the body portion 32.

In still yet another example, the first example method can further include the step of tightening the nut 60 to secure the instrument probe 14 to the body portion 32 by finalizing the position of the ferrule 50 relative to the instrument probe 14. This step is performed after the instrument probe 14 is inserted through the fitting assembly 30. Furthermore, the ferrule 50 with the alignment feature 54 allows a loosening operation of the nut 60 to allow a different instrument or different instrument probe 14 to be inserted into the fitting assembly 30. There is no need to remove the ferrule 50 from the body portion 32, as the instrument probe 14 can be properly received by the fitting assembly 30 by loosening the nut 60. A tightening of the nut 60 will then once again secure the different instrument or instrument probe 14 relative to the fitting assembly 30. The amount of loosening and tightening of the nut 60 can be relatively minimal to achieve the result of pre-aligning the ferrule 50 and fully securing the ferrule 50 to the instrument probe 14. For example, a range of approximately 1.75 to 2 turns of the nut 60 can be enough to fully secure the instrument probe 14. In another example, the first example method can further include the step of fastening a nut 60 and providing a pusher mechanism 170 configured for engaging the ferrule 50 during the step of fastening of the nut 60 on the first end 36 of the body portion 32.

In another example, the method can include providing the fitting assembly in a thermocouple arrangement. The method can further include the steps of providing a first connector 16 configured to have a thermocouple probe lead 18 extending therefrom, and having an interior configured to receive an electrical connection terminus of the thermocouple probe lead 18. The fitting assembly 30 can be configured to secure the thermocouple probe lead 18 relative to the instrument probe 14. The method further includes the step of providing a second connector 20 configured to have an electrical connection lead extending therefrom, and having an interior configured to receive a terminus of the electrical connection lead, wherein the first and second connectors 16, 20 provide an electrical conduction path between the thermocouple probe lead 18 and the electrical connection lead. Other example methods can also be provided including any of the fitting assemblies 30, 130, 230 using any or all of the steps or structure described and/or shown in the drawings.

It should be evident that this disclosure is by way of example and that various changes may be made by adding, modifying, or eliminating details without departing from the scope of teachings contained in this disclosure. In particular, the discussion and drawings are presented herein by way of example only and other variations are contemplated and considered within the scope of the invention.

What is claimed:

1. A fitting assembly configured to secure an instrument probe including:
a body portion including a bore for receiving the instrument probe; and
a ferrule configured for receiving and aligning the instrument probe, wherein the ferrule includes an alignment feature configured for contacting the bore upon insertion into the body portion, and wherein the alignment feature of the ferrule constricts in response to contact with the bore to pre-align the ferrule for reception of the instrument probe.

2. The fitting assembly as set forth in claim 1, further including:
a nut configured for engaging a first end of the body portion, wherein the nut contacts the ferrule for inserting the alignment feature of the ferrule into the bore of the body portion.

3. The fitting assembly as set forth in claim 1, wherein the alignment feature of the ferrule includes a first portion of a first enlarged diameter and a second portion of a second enlarged diameter.

4. A fitting assembly configured to secure an instrument probe including:
a body portion including a bore for receiving the instrument probe;
a ferrule configured for receiving and aligning the instrument probe, wherein the ferrule includes an alignment feature configured for contacting the bore upon insertion into the body portion; and
a pusher mechanism configured for engaging the ferrule and inserting the ferrule into the bore and wherein the alignment feature of the ferrule constricts in response to contact with the bore to pre-align the ferrule for reception of the instrument probe.

5. The fitting assembly as set forth in claim 4, wherein the alignment feature of the ferrule includes a first portion of a first enlarged diameter and a second portion of a second enlarged diameter.

6. The fitting assembly as set forth in claim 4, further including:
a nut configured for engaging a first end of the body portion, wherein the nut contacts the pusher mechanism for inserting the alignment feature of the ferrule into the bore of the body portion.

7. The fitting assembly as set forth in claim 6, wherein a first end of the pusher mechanism is substantially flat for contacting the nut and a second end of the pusher mechanism is generally conical for contacting the ferrule.

8. A method of assembling a fitting assembly for securing an instrument probe including the steps of:
providing a body portion including a bore for receiving the instrument probe;
providing a ferrule configured for receiving and aligning the instrument probe, wherein the ferrule includes an alignment feature configured for contacting the bore upon insertion into the body portion; and
inserting the ferrule into the bore of the body portion wherein the alignment feature of the ferrule constricts in response to contact with the bore to pre-align the ferrule for reception of the instrument probe.

9. The method of claim 8, further including the step of:
inserting the instrument probe into the body portion of the fitting assembly without removing the ferrule from the body portion of the fitting assembly.

10. The method of claim 8, further including the step of:
providing a pusher mechanism configured for inserting the ferrule into the body portion.

11. The method of claim 8, further including the step of:
fastening a nut on a first end of the body portion, wherein fastening of the nut inserts the alignment feature of the ferrule into the bore of the body portion.

12. The method of claim 11, further including the step of:
tightening the nut to secure the instrument probe to the body portion by finalizing the position of the ferrule relative to the instrument probe.

13. The method of claim 11, further including the step of:
providing a pusher mechanism configured for engaging the ferrule during the step of fastening of the nut on the first end of the body portion.
